(19) United States
(12) Patent Application Publication
(10) Pub. No.: US 2025/0089589 A1
(43) Pub. Date: Mar. 20, 2025

(54) THREE-POINT HITCH ADAPTERS, ATTACHMENTS, BALE WRAP ROLLING ASSEMBLIES, AND RELATED METHODS OF USE

(71) Applicant: Gecco Inc., County of St. Paul (CA)

(72) Inventors: Chris Moser, County of St. Paul (CA); Justin Moser, County of St. Paul (CA); Tyran Shelton, County of St. Paul (CA)

(73) Assignee: Justin Moser, County of St. Paul, AB (CA)

(21) Appl. No.: 18/369,840

(22) Filed: Sep. 19, 2023

(51) Int. Cl. A01B 59/06; A01B 76/00; A01D 87/12; B62D 49/06; B62D 53/10

(52) U.S. Cl. CPC A01B 59/066; A01B 76/00; A01D 87/122; B62D 53/10; B62D 49/065

(57) ABSTRACT

A three-point hitch adapter has: a structural frame; a three-point hitch connector at a leading end of the structural frame; a three-point hitch at a trailing end of the structural frame; and a fifth wheel coupling mounted on the structural frame. A bale wrap roller assembly has a structural frame; a hitch connector at a leading end of the structural frame; a wrap-receiving spool; and a motor connected to rotate the wrap-receiving spool.

### TECHNICAL FIELD

This document relates to three-point hitch adapters, attachments, and related methods of use.

### BACKGROUND

The following paragraphs are not an admission that anything discussed in them is prior art or part of the knowledge of persons skilled in the art.

Three-point hitch connectors are common on various tractor tools, such as bale spears and other devices, which may include a hitch for a trailer. Bale wrap rollers include standalone units that are towed into the field to collect and create rolls of spent bale wrap.

### SUMMARY

A three-point hitch adapter is disclosed comprising: a structural frame; a three-point hitch connector at a leading end of the structural frame; a three-point hitch at a trailing end of the structural frame; and a fifth wheel coupling mounted on the structural frame.

A combination is disclosed, comprising: a three-point hitch adapter; and a tool apparatus, which has a three-point hitch connector that is mounted to the three-point hitch of the three-point hitch adapter.

A bale wrap roller assembly is disclosed comprising: a structural frame; a hitch connector at a leading end of the structural frame; a wrap-receiving spool; and a motor connected to rotate the wrap-receiving spool.

In various embodiments, there may be included any one or more of the following features: The fifth wheel coupling comprises a top plate that defines a kingpin-receiving slot. The top plate is secured above or forms part of a coupling cover that mounts by reversible connectors to an upper member of the structural frame. The structural frame comprises opposed upright post members, and the reversible connectors comprises fasteners passed through aligned apertures in the coupling cover and the upright post members. The fasteners comprise lynch pins that extend parallel and coaxial with one another. A kingpin gate lock is structured to move between a retracted position in which a lateral mouth of the kingpin-receiving slot is unobstructed, and a locked position in which the lateral mouth is blocked to prevent kingpin removal. The gate lock comprises a slide bar. The slide bar is connected to a hydraulic actuator. The slide bar is connected to a manual release bar for manual operation of the slide bar. A slide bar lock is provided. The three-point hitch comprises a pair of base quick-connect hooks and a top quick-connect hook. The top quick-connect hook is structured to be selectively lockable in a range of different elevation positions relative to the pair of base quick-connect hooks. Quick-connect locks are provided, for each of the pair of base quick-connect hooks, and that are biased to permit entry but prevent exit of a lateral pin from a three-point hitch connector. The tool apparatus comprises a bale spear. The tool apparatus comprises a bale wrap roller. Each of the tool apparatus and the three-point hitch adapter comprise structural frame members that are oriented to collectively define a power take off passage through both the tool apparatus and the three-point hitch adapter. A fifth wheel trailer is hitched to the fifth wheel coupling. Connecting a fifth wheel trailer to the fifth wheel coupling. The hitch connector comprises a three-point hitch connector. The three-point hitch connector comprises a pair of base quick-connect pins and a top quick-connect pin. The hitch connector comprises a fifth wheel connector. The fifth wheel connector comprises: a cantilevered subframe neck mounted on a leading end of the structural frame; and a kingpin depending from the cantilevered subframe neck. A wrap entry guide is at a trailing end of the structural frame. The wrap entry guide comprises a wrap guide subframe with beams that are parallel with one another and the wrap-receiving spool, spaced from one another, and oriented transverse to and along a feed axis defined by the wrap-receiving spool. The wrap guide subframe is connected to swing between: a deployed position in which the wrap guide subframe extends outward along the feed axis; and a stowed position. A twine feeder is provided. The twine feeder comprises: a twine dispenser; and twine guides oriented to guide twine from the twine dispenser to wrap around the wrap-receiving spool in use. The twine feeder comprises a twine feed bar, which is structured to receive twine from the twine guides and to slide along a rail transverse to a feed axis defined by the wrap-receiving spool. The wrap-receiving spool comprises a roller axle and roller discs spaced from one another along the roller axle to define a wrap-receiving zone. The motor is mounted to drive the roller axle by an endless drive loop. One or both the roller axle and the roller discs comprise a wrap hook part that at least partially defines a wrap end-receiving slot. An end of the roller axle comprises a handle, and the roller axle is structured to move along a roller axis between: a locked, deployed position where the roller axle is connected to be rotated by the motor; and a retracted position where the roller axle is withdrawn from the wrap-receiving zone to release a roll of bale wrap in use. The motor comprises a hydraulic motor with hydraulic controls that incorporate hydraulic fluid supply and return ports. Ground-engaging retractable legs are configured to raise the structural frame above a ground surface when deployed. Operating the motor of the bale wrap roller of to rotate the wrap-receiving spool to wrap a bale wrap into a roll.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a side elevation view of a tractor with a three-point hitch, with an adapter mounted to the three-point hitch, and a bale spear mounted to a three-point hitch of the adapter, along with a gooseneck trailer mounted to a fifth wheel coupling on the adapter, the trailer mounting a number of hay bales. The location of a hay bale on the bale spear is shown in dashed lines.

FIG. 2 is a partially exploded side elevation view of a three-point hitch of a tractor and the bale spear and adapter from FIG. 1.

FIG. 3 is a partially exploded perspective view of the three-point hitch of a tractor and the bale spear and adapter from FIG. 1.

FIG. 4 is a trailing-end view of the bale spear and adapter from FIG. 1.

FIG. 5 is a perspective leading-end view of the adapter from FIG. 1.

FIG. 6 is a partially exploded perspective trailing-end view of the adapter from FIG. 1, with the fifth wheel coupling above the structural frame of the adapter.

FIG. 7 is a side elevation view of the adapter of FIG. 1.

FIG. 8 is a side elevation view of the adapter of FIG. 1. with the fifth wheel coupling removed.

FIG. 9 is a trailing end view of the adapter of FIG. 1.

FIG. 10 is a top plan view of the adapter of FIG. 1.

FIG. 11 is a bottom plan view of the fifth wheel coupling of the adapter of FIG. 1, with the gate bar shown in a retracted position in solid lines and the locked position in dashed lines.

FIG. 12 is a bottom perspective view of the fifth wheel coupling of the adapter of FIG. 1.

FIG. 13 is another bottom perspective view of the fifth wheel coupling of the adapter of FIG. 1.

FIG. 14 is a partially exploded perspective view of a bale wrap roller.

FIG. 15 is a side elevation view of the bale wrap roller of FIG. 14.

FIG. 16 is a leading end view of the bale wrap roller of FIG. 14.

FIG. 17 is a trailing end view of the bale wrap roller of FIG. 14.

FIG. 18 is a top plan view of the bale wrap roller of FIG. 14, with a roll of bale wrap mounted on the spool.

FIG. 19 is a perspective view of a quick-connect pin from a three-point hitch connector.

FIG. 20 is a perspective view of a handle end of the spool axle from the bale wrap roller of FIG. 14.

FIG. 21 is a perspective view of a pivot mechanism for stowing and deploying a wrap guide subframe.

FIG. 22 is a perspective view of a ground-engaging leg of the bale wrap roller of FIG. 14, in a stowed position.

FIGS. 23 and 24 are different perspective views of a telescopic ground-engaging leg and hydraulic controls of the bale wrap roller of FIG. 14.

FIG. 25 is a perspective view of the twine feed system of the bale wrap roller of FIG. 14.

### DETAILED DESCRIPTION

Immaterial modifications may be made to the embodiments described here without departing from what is covered by the claims.

Heavy equipment refers to a category of machinery designed for performing substantial construction, earthmoving, and material handling tasks. These machines are typically characterized by their significant size, power, and durability. Heavy equipment includes a wide range of vehicles and machinery, such as excavators, bulldozers, backhoes, loaders, cranes, dump trucks, and tractors, among others. These machines are commonly used in construction, mining, agriculture, and infrastructure development. They are equipped with robust engines, hydraulics, and various attachments or implements to efficiently manipulate and transport heavy loads, excavate, grade, and perform other essential functions. Proper operation and maintenance of heavy equipment are critical to ensuring safety, productivity, and the successful completion of large-scale projects.

Tractors are versatile, motorized agricultural or industrial vehicles designed primarily for pulling or pushing heavy loads, plowing fields, and powering various implements and machinery. They are equipped with powerful engines, often with multiple cylinders, capable of delivering high torque for performing a wide range of tasks. Tractors typically feature large, rugged tires for traction and stability on various terrains. These vehicles commonly have a Power Take-Off (PTO) system that enables them to transfer mechanical power to attached implements, such as plows, cultivators, and mowers, allowing for efficient agricultural and industrial operations. Tractors come in various sizes and configurations, from compact utility tractors for smaller tasks to larger, specialized models tailored to specific applications like row-crop farming or construction. Modern tractors often incorporate advanced technologies such as Global Position System (GPS) guidance, automated controls, and ergonomic cabins for enhanced precision and operator comfort.

Connecting tools to a tractor involves the attachment of implements and equipment to the tractor's hitch system or other connection points, facilitating various agricultural or industrial tasks. Tractors are typically equipped with a three-point hitch or drawbar, which are standardized systems for linking implements securely. The three-point hitch includes two lower arms and a top link, providing stability and control over the attached tool's depth and angle. Implements often come with pins or hooks that are aligned with the tractor's hitch components and secured in place using locking mechanisms or hydraulic actuators. Additionally, some tractors feature a Power Take-Off (PTO) connection that transfers mechanical power from the tractor to the tool, enabling the operation of machinery like rotary tillers, balers, and pumps. Properly connecting tools to a tractor is essential to ensure safety, efficiency, and precise control during various agricultural or industrial operations.

The three-point hitch system is a widely used and standardized mechanism for connecting implements and equipment to tractors in agriculture and industry. It consists of three primary components: two lower lift arms and an upper top link, forming a triangular configuration when viewed from the side. The lower lift arms are typically hydraulically controlled by the tractor operator and can be raised or lowered to adjust the implement's working depth or height above the ground. The top link, often adjustable in length, provides additional support and control over the implement's angle or tilt. The three-point hitch system offers several advantages, including efficient power transfer, stability, and the ability to control the implement's position during operation. Its widespread adoption has led to a high degree of compatibility among tractors and various implements, making it a versatile and indispensable tool for a wide range of agricultural and industrial tasks.

While three-point hitch systems are highly versatile and widely used in agricultural and industrial settings, they can sometimes encounter certain issues. One common problem is misalignment, where the tractor's hitch points and the implement's attachment points do not match precisely. This can result in difficulty attaching or detaching implements, affecting efficiency and safety. Additionally, uneven terrain can pose challenges, as it may cause the implement to tilt or drag improperly, impacting the quality of work. Another issue is the potential for mechanical wear and tear, especially in the hydraulic components responsible for raising and lowering the lower lift arms. Over time, hydraulic leaks, worn seals, or damaged linkage components can lead to reduced performance and require maintenance or repairs. Proper setup, regular maintenance, and operator training can help mitigate these problems and ensure the reliable performance of three-point hitch systems.

Adapters for three-point hitches are specialized devices designed to enhance the versatility and compatibility of tractors and implements. These adapters bridge the gap between tractors with one category of hitch and implements with a different category, ensuring that they can be securely connected and used together. Adapters are available in various configurations to accommodate different hitch categories and sizes, such as converting from a Category 1 to Category 2 or 3 or vice versa. They typically feature sturdy construction, with durable materials like steel, and include attachment points for both the tractor and implement sides. These adapters are especially valuable in situations where a tractor and implement do not have matching hitch categories, allowing operators to maximize the utility of their equipment and use a wider range of implements with their tractors.

Connecting a trailer to an agricultural tractor is a vital operation in the farming industry. Trailers are used to transport a wide range of agricultural goods, such as harvested crops, livestock, or heavy machinery, and linking them to a tractor enables efficient and flexible short-distance logistics within the agricultural context. This connection is commonly used for tasks like hauling harvested produce from the fields, moving livestock between locations, or transporting bulky farm equipment. The attachment between the trailer and the agricultural tractor typically involves a hitch or coupling mechanism, ensuring a secure connection and allowing the tractor to tow the trailer safely. Properly connecting a trailer to an agricultural tractor is crucial for maintaining stability, control, and safety during various farming activities, making it an essential aspect of modern agricultural operations.

Various hitch systems may be used to connect a tractor and a trailer. One common type is the three-point hitch system discussed above. Fifth wheel hitches, typically used in the transportation sector, provide stability and weight distribution for semi-trucks and trailers. Pintle hitches offer heavy-duty towing capabilities, often utilized in military and construction applications. Gooseneck hitches are commonly found in towing large trailers or horse trailers, providing a secure connection within the truck bed. Each hitch system is designed with specific purposes in mind, catering to the needs of various tasks and industries, ensuring safe and efficient equipment operation.

The primary difference between a gooseneck trailer and a fifth-wheel trailer lies in the hitching mechanism and where they attach to the towing vehicle. A gooseneck trailer uses a gooseneck hitch, which is a ball hitch located in the bed of a pickup truck or other tow vehicle. The hitch ball of a gooseneck trailer connects to a receptacle in the bed of the towing vehicle, typically over or just in front of the rear axle. Gooseneck trailers are commonly towed by pickup trucks and some larger flatbed trucks. Gooseneck trailers tend to provide better maneuverability, as they pivot on the hitch ball in the truck bed. By contrast, fifth-wheel trailers use a special fifth-wheel hitch, which is typically installed in the bed of a pickup truck or other tow vehicle. The fifth-wheel hitch of the trailer connects to a kingpin on the trailer, creating a secure and stable connection. Fifth-wheel trailers are generally towed by trucks with a fifth-wheel hitch installed. Fifth-wheel hitches offer greater stability and weight-carrying capacity compared to gooseneck hitches, making them suitable for larger and heavier trailers. Both types of trailers have their advantages and are chosen based on the specific towing needs and preferences of the user. Both types of trailers are used in agriculture, however, fifth-wheel trailers are preferred in some agricultural contexts for their stability and capacity to handle larger loads.

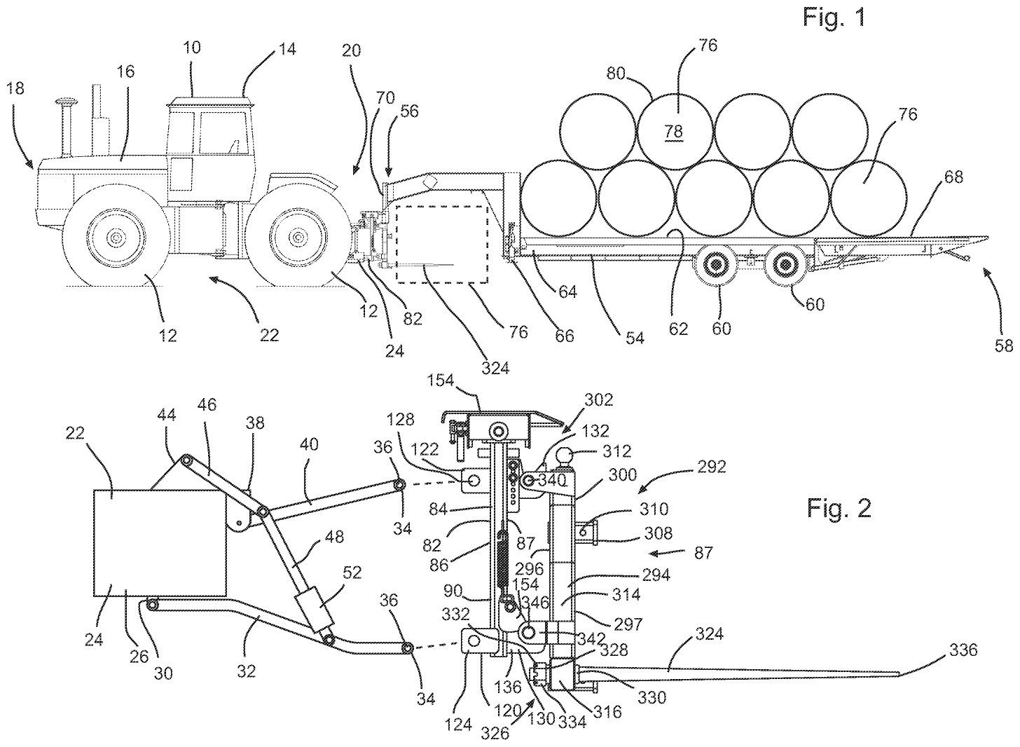

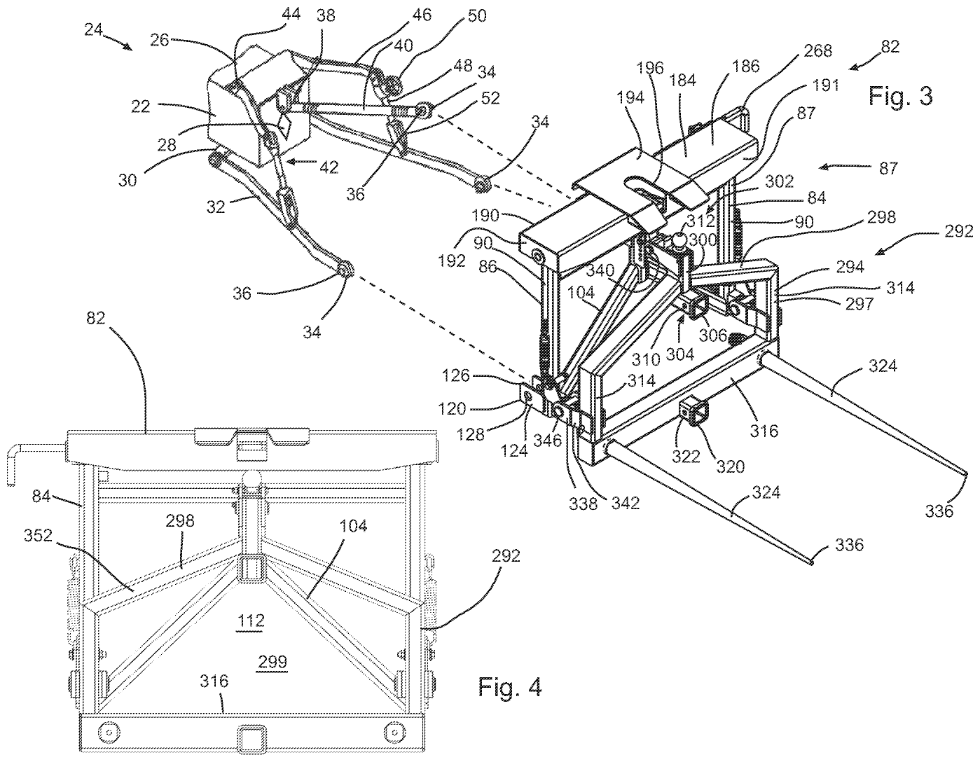

Referring to FIG. 1, a tractor 10 is illustrated with a three-point hitch 24 on a trailing end 20 of the vehicle. The tractor 10 may have various parts, such as ground engaging members, for example wheels 12, a cab 14, an engine compartment 16, and a hydraulic power system 22. Referring to FIGS. 2 and 3, the three-point hitch 24 may have various parts, such as a main body 26 or frame, with three separate linkages, shown in the form of base stabilizing arms 32, and a center top link arm 40. The base stabilizing arms 32 may mount to body 26 via stabilizing arm brackets 30, which permit pivoting motion. The top link arm 40 may mount to body 26 view a center top link bracket 38. Lift arm levelling assemblies 42 may mount on body 26 for adjusting the elevation of the arms 32. Each assembly 42 may incorporate various parts, such as an upper arm bracket 44, pivotally mounting upper arms 46, which pivotally mount to length-adjustable rotatable lift arms 48. Lift arms 48 may connect to threaded mounting arms/leveling box drop arms 52, whose length may be adjusted by a suitable mechanism such as rotating the arms 52 relative to arms 48, and/or using a crank 50. Each of the three arms 32 and 40 may define hitch ends 34 with pin apertures 36 for mounting to a tool apparatus desired to be connected to the tractor 10.

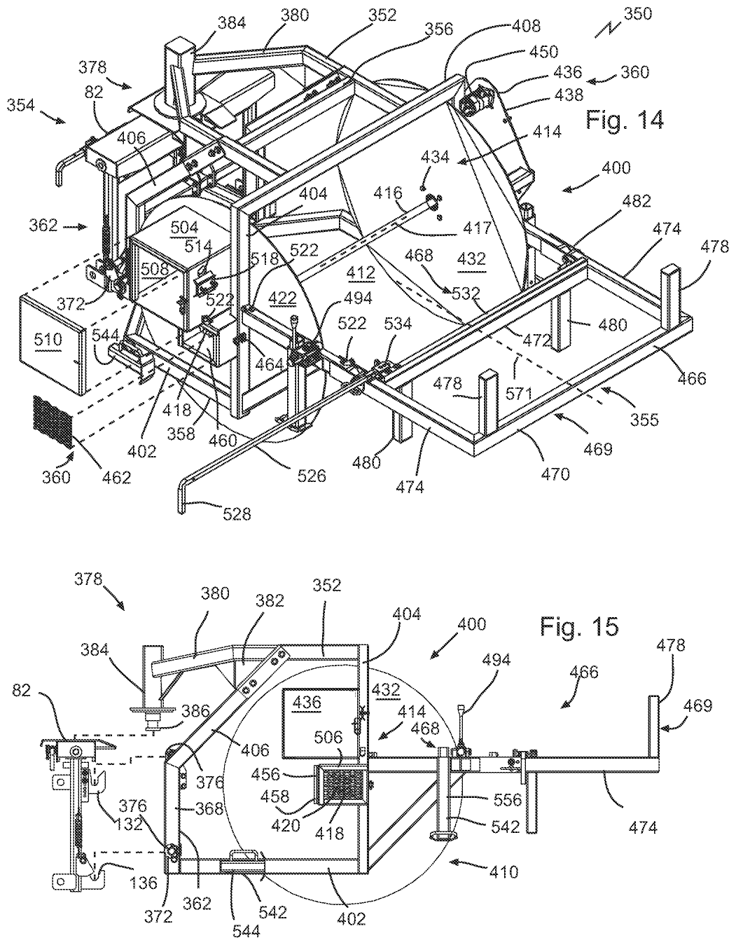

Referring to FIGS. 2-3. a three-point hitch adapter 82 is illustrated, for mounting to the three-point hitch 24 of the tractor, and for itself providing a three-point hitch for another tool. Adapter 82 may comprise a structural frame 84, a three-point hitch connector 120, a three-point hitch 130, and a fifth wheel coupling 184. The structural frame 84 may be formed of a plurality of structural members. The three-point hitch connector 120 may be located at a leading end 86 of the structural frame 84, opposed to a trailing end 87. The three-point hitch 130 may be located at the trailing end 87 of the structural frame 84. The fifth wheel coupling 184 may be mounted on the structural frame 84. Referring to FIG. 1, the use of the adapter 82 may permit the user with the flexibility of connecting a variety of tool apparatuses, such as a bale spear assembly 292, or a bale wrap roller assembly 350 (FIG. 14), in addition to providing the ability to tow a fifth wheel trailer 54, either simultaneously or in sequence.

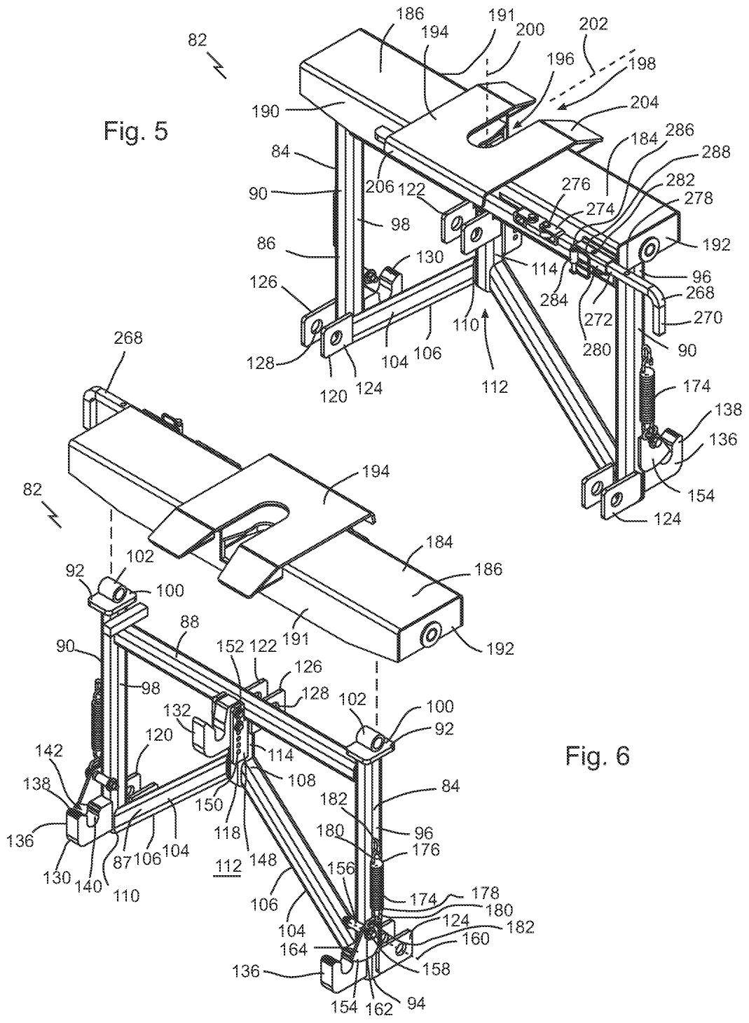

Referring to FIGS. 1-3 and 5, the structural frame 84 of the adapter 82 may have suitable features. The structural frame 84 may be formed of suitable structural members, such as upper beam members 88, side post members 90 and angled base members 104. In the example shown, all of the aforementioned members cooperate to form a peripheral closed structure on which to mount the various parts of the adapter 82. Members are shown as box beams, however other styles of members may be used, including I-beams, and others. Base members 104 may be angled, for example extending from respective base ends 110 to meet at an apex 108, such that lower edges 106 of the members 104 define a PTO passage 112 aligned in use to pass a PTO from a tractor 10. At the apex 108 of members 104, a center post member 114 may be mounted, rising from a bottom end 118 at apex 108 to a top end 116. The post member 114 may mount a top connector 122 of the three-point hitch connector 120. Side post members 90 may extend from a top end 92 to a bottom end 94, defining outer side edges 96 and inner side edges 98. Upper beam member 88 may extend between the post members 90. Each post member 90 may define a fifth wheel coupling connection system, such as provided by pin collars 102, which may be mounted on upper plates 100 or in other similar fashion. Collars 102 may be parallel and coaxial as shown, or provided in other arrangements.

Referring to FIGS. 1-3 and 5, the three-point hitch connector 120 may have a suitable structure. The connector 120 may comprise a top connector 122, and side connectors 124. The connectors 122 and 124 may have suitable structures, such as formed by parallel spaced bracket plates or arms 126, with aligned pin apertures 128 for aligning with pin apertures 36 in hitch ends 34 of arms 32 and 40 of the three-point hitch 24 of the tractor 10. In some cases, a mechanism may be provided to adjust the spacing, position, or elevation of one or more of the connectors 122 and 124, to permit the structure to be matched with the specific three-point hitch that the adapter 82 is being mounted to.

Referring to FIGS. 1-10, the adapter 82 may comprise a suitable three-point hitch 130. The hitch 130 may comprise a top connector 132, and side connectors 136. The side connectors 136 and/or top connector 132 may be mounted adjacent the connectors 122 and 124, or may be offset to adjust for the sizes of different tools. In some cases, a mechanism may be provided to adjust the spacing, position, or elevation of one or more of the connectors 132 and 136, to permit the structure to be matched with the specific three-point hitch connector of the tool that the adapter 82 mounts in use. In the example shown, the top connector 132 may be structured to be selectively lockable in a range of different elevation positions relative to the pair of base connectors 136. Such may be accomplished using a height adjustment bracket 148, which may be mounted to or form part of post member 114. The brackets 148 may have a plurality of aligned apertures 150 through which to pass a lynch pin 152, or other fastener, through an aligned aperture (not shown) in the top connector 122. Other methods of adjusting elevation may be used.

Referring to FIGS. 1-10, in some cases the three-point hitch 130 may be structured as a quick-connect hitch. For example, as shown, the three-point hitch 130 may comprise a pair of base quick-connect hooks (connectors 136) and a top quick-connect hook (connector 132). Each connector may form a hook, with hook arms 138 that define a pin insertion slot 140 via an open slot mouth 142 defined by the hook. In use, all hook arms 138 are aligned such that the respective pin insertion axes 144 defined by each slot mouth 142 align in parallel to permit all corresponding pins from the three-point hitch connector of the respective tool to mate and match in one motion. In the example shown in FIGS. 2 and 3, the respective tool (bale spear assembly 292) may mount to the connectors via three corresponding lateral lynch pins 346.

Referring to FIGS. 2-3, and 5-8, the hitch 130 may be structured to lock the tool in place. For example, a pair of hitch locks 154 may be provided to lock the side connectors 136. In the example shown, the locks 154 are quick-connect locks, and for each of the pair of base quick-connect hooks, the locks 154 are biased to permit entry but prevent exit of a lateral pin 346 from a three-point hitch connector. Each lock 154 may comprise a pivotal cam lever plate 164, which may be mounted to pivot relative to the structural frame 84, for example via a pin collar 156 and pivot pin 158, which mount to plate 164 using a nut or flange 162. The cam lever plate 164 may be structured to pivot to slice into the pin slot 140 in a plane transverse a pin axis defined by the slot 140. The plate 164 may define a top end 166 about which a pivot axis 160 is defined, with a leading entry ramp 170 defined as an edge, ending at a tip 172. Below the tip 172, a base ramp 168 may extend to cause any pin 346 that attempts to leave the slot 140 to rotate the plate 164 against a biasing element. A biasing member, such as a spring 174, may be mounted at its top end 176 to a hook 180 of post member 90, and at its bottom end 178 via a hook 180 to plate 164. A pin 346 that is entering the slot 140 will contact leading entry ramp 170, causing the plate 164 to rotate such that the tension on the spring 174 is reduced, permitting entry. However, once the pin 346 clears the tip 172, the plate 164 will rotate back over the pin 346. If the pin 346 attempts to leave the slot 140, the pin 346 will contact the base ramp 168, causing the plate 164 to rotate in the opposite direction as on entering, to elongate the biasing member to create resistance to unlocking. Thus, the locks 154 may be used to retain the connection between the three-point hitch and the tool. To release the lock, the user may manually elongate the spring 174 or turn the cam plate 164 to permit the pin 346 to exit.

A fifth wheel trailer may connect to a fifth wheel coupling. Such a coupling may have a semicircular metal plate, referred to as the fifth wheel, mounted horizontally on the towing vehicle's chassis. The fifth wheel plate may feature a locking mechanism for a kingpin, which is a cylindrical protrusion on the trailer's front underside. When a trailer is coupled with a truck, the kingpin slides into the fifth wheel's open slot, and the locking mechanism secures the connection. This design provides a stable and pivotable joint, enabling the trailer to articulate independently from the towing vehicle. Fifth wheel couplings are known for their strength, durability, and ability to handle substantial loads, making them suitable for applications such as long-haul trucking, transportation of heavy equipment, and various industrial and commercial tasks.

Referring to FIGS. 1-10, the fifth wheel coupling 184 may have a suitable structure. The fifth wheel coupling 184 may define a top face 186 for receiving a kingpin, as well as a base 188, leading and trailing ends 190, 191, respectively, and sides 192. The coupling 184 may comprise a top plate 194 or plates that defines a kingpin-receiving slot 196. The top plate 194 may have a horseshoe shape as is used in fifth wheel couplings. The kingpin slot 196 may define a mouth 198 for lateral entry of the kingpin during backing up of the tractor 10. The mouth 198 and slot 196 may define a kingpin insertion axis 202. The plate 194 may be structured to facilitate entry of the kingpin, such as by using ramped tips 204 at either side of the mouth 198, to guide the kingpin laterally into the slot 196 along a mouth insertion axis 202. The plate 194 may also comprise a leading end skirt 206.

Referring to FIGS. 1-10, the top plate 194 may be secured above or form part of a coupling cover 208. The cover 208 may form a structure frame, and may mount by reversible connectors, such as pins 228, to an upper member of the structural frame 84. In the example shown, the structural frame 84 may comprise opposed upright post members 90, and the reversible connectors comprises fasteners, such as lynch pins 228 that are passed through aligned apertures 226 in the coupling cover 208 and the upright post members 90, for example via pin collars 102 in members 90. The lynch pins 228 may extend parallel and coaxial with one another as shown to provide two or more attachment points. In the example shown, each pin 228 has its terminal end secured within apertures 230 via a nut 234, which has apertures 230 for a second fastener, namely a lynch pin 232. The pins 228 may pass through cross beams 236 in the interior 218 defined by the cover 208. The cover 208 may define a top plate member 210, a leading end member 212, and a trailing end member 216. Side member plates 224 may form sides of the cover 208, and may define pin apertures 226. The leading end member 212 may define a slide gate bare guide slot 214 to the interior 218, to permit the passage and operation of a slide gate bar 238. The trailing end member 216 may define a kingpin slot 220 and mouth 222 similar to those of the top plate 194. Cross beams 236 in the interior 218 may support the structure of the cover 208.

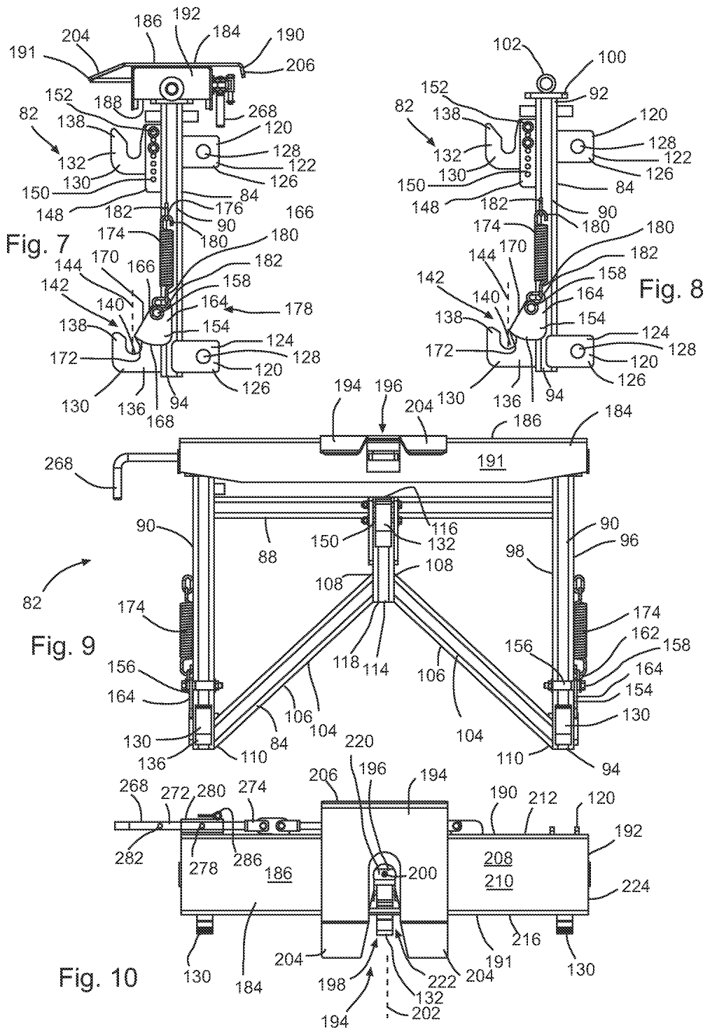

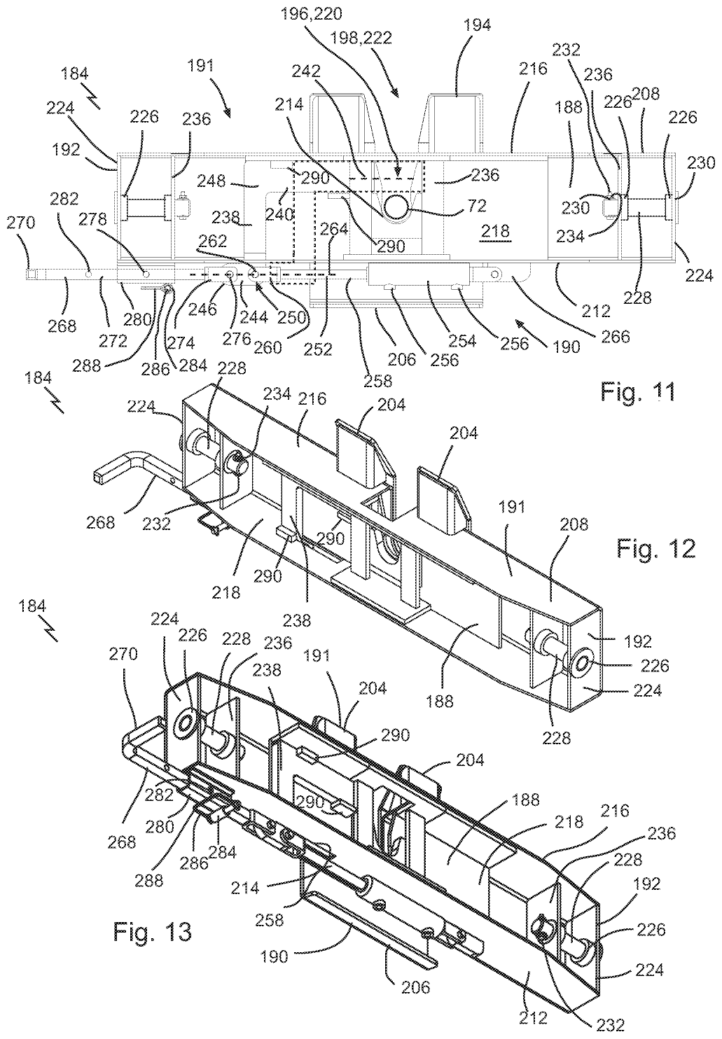

Referring to FIGS. 7-8 and 11-13, a kingpin gate lock may be used to secure the fifth wheel coupling 184 to a trailer 54 (FIG. 1). A kingpin gate lock, such as an L-shaped slide gate bar 238 may be used, and may be structured to move between a retracted position shown in solid lines, in which a lateral mouth 198 of the kingpin-receiving slot 196 is unobstructed, and a locked position, shown in dashed lines in FIG. 11, in which the lateral mouth 198 is blocked to prevent kingpin 72 removal. The bar 238 may have suitable properties, and may comprise a slide bar as shown, which is a bar that slides along one axes of movement. In the example shown, the bar 238 may comprise a gate arm 240 that moves along a gate drive axis 241 to block and open the mouth 198. The arm 240 may extend at a right angle from a drive arm 244, which moves along a drive axis 242. Various guide parts 290 and bushing surfaces may guide and align the movement of the guide bar.

Referring to FIGS. 7-8 and 11-13, the slide bar 238 may be connected to an actuator, such as a hydraulic actuator 252. The actuator 252 may comprise a hydraulic cylinder 254 with a piston 258, which is structured to move along a drive axis 264. The cylinder 254 may have ports 256 to supply and return hydraulic fluid from the hydraulic system of the tractor 10. The piston 258 may connect to a bracket 260 at the pistons 258 actuating end, and a fastener such as a clevis pin 262 may pass through apertures 250 to secure the bracket 260 to the drive arm 244. The cylinder 254 may be secured to cover 208 via a mounting bracket 266. In some cases, other actuators may be used, such as linear or screw actuators.

Referring to FIGS. 7-8 and 11-13, 9, the slide bar 238 may be connected to a manual release bar 268 or lever for manual operation of the slide bar. The bar 268 may have a handle 270 and a main body 272 or shaft. The main body 272 may connect to a bracket 274 at the bodies 272 actuating end, and a fastener such as a clevis pin 276 may pass through apertures 278 to secure the bracket 274 to the drive arm 244. A bar lock may be provided. The bar 268 and/or piston 258 may comprise locking apertures 278, which may align with apertures 282 in a guide collar 280, to permit a locking pin 286 to be used to secure the bar 268 in place. The pin 286 may be stored in a pin storage collar 284, which may have a handle 288 and other suitable parts.

Referring to FIGS. 1-4, in some cases the adapter 82 may be combined with a tool apparatus. The tool apparatus, for example a bale spear assembly 292 as shown, may have a three-point hitch connector 338 that is mounted and/or mountable to the three-point hitch 130 of the three-point hitch adapter 82. Referring to FIG. 14, the tool apparatus may comprise a bale wrap roller assembly 350. Other tool apparatus may be used, such as a Drawbar hitch receiver, a Bale Unroller, a Pallet Fork, a Vegetable Digger, a Header Mover, a Boom, a Back blade, a Box Spreader, a Landscape rake, a Dethatcher, a Sweeper, a Chipper, and a Mower, although other tools may be used.

Referring to FIGS. 1-4, a bale spear assembly 292 is illustrated as an example tool to connect to adapter 82. The assembly 292 may have a structural frame 294, which may define leading and trailing ends 296, 297, respectively. The frame 294 may be formed by suitable structural members, such as angled upper members 298, a neck member 300 (defining a top of the frame 294) at an apex of the upper members 298, side post members 314 (defining sides 360 of the frame 294), and a base beam member 316 (defining a base of the frame 294). The top 302 of the frame 294 may be structured to be below the hitch coupling 184 to avoid conflicting with the usage of the coupling 184 as a hitch while the assembly 292 is installed on the adapter 82. The neck member 300 may define the top 302 of the frame 294. A ball hitch 312 may be mounted on neck member 300 and may be used instead of the fifth wheel coupling, or may be used to mount a gooseneck trailer. One or more of an upper hitch mount 306 and a lower hitch mount 320 may be used, for example no neck member 300 and base beam member 316, respectively, to provide options for other hitch connection points or to connect other equipment or parts to assembly 292. Bale spears 324 may extend from the frame 294 in a suitable fashion, such as in the trailing direction, spaced from one another yet parallel to permit stabbing of a bale with the spears. Bale spears 324 may mount in a suitable fashion, for example, a base 326 of each spear 324 may be defined by a male part 328 with a bushing or sleeve 330 that passes through apertures in the base box member 316, with a nut 334 secured a threaded end 332 of the spear 324. The tips 336 of each spear 324 may be tapered to provide a sharp stabbing structure for ease of insertion in a bale in use. The assembly 292 may have a suitable three-point connector 338, such as having a top connector 340, and side connectors 342. Bracket arms 344 may mount lynch pins 346 to operate as quick connectors with the hooks of the three-point hitch of the adapter 82. Referring to FIG. 4, each of the tool apparatus and the three-point hitch adapter 82 may comprise structural frame members that are oriented to collectively define a power take off passage (passages 112 and 229 of adapter 82 and assembly 292, respectively, align in use in this fashion) through both the tool apparatus and the three-point hitch adapter. Thus, the operation of a PTO is not hindered by the design of the adapter 82 and tool apparatus.

Referring to FIG. 1, the combination of tractor 10, tool apparatus (such as bale spear assembly 292), and a trailer 54 may provide useful functionality. In the example shown, the tractor 10 mounts adapter 82, which mounts bale spear assembly 292, while fifth wheel coupling 184 mounts to the trailer 54. The trailer 54 may have a suitable structure, such as a deck 62 and chassis 64 defining leading and trailing ends 56 and 58, respectively, with ground engaging members such as wheels 60, a deck 62, legs, such as outriggers or drop legs 66, and a loading ramp 68. In the embodiment shown, the combination of elements reduces the number of vehicles that must be brought into a field to efficiently collect and transport hay bales 76 off the field. In a typical scenario, to accomplish this task the farmer would have to move the bale spear assembly 292 and trailer separately. However, in the example shown, the user may drive the trailer 54 and assembly 292 out to the field, park and disconnect the trailer 54, use the assembly 292 to engage and load bales 76 on the deck 62, until completion, at which point the trailer 54 may be rehitched and the entire assembly driven off to storage. Without the adapter 82, the user would either need two vehicles or multiple trips to achieve the same result in a less efficient and more time-intensive fashion. Hay bales 76 may be loaded in suitable fashion, for example rested on cylindrical body 80 sides with ends 78 on either side of the deck 62, although other configurations may be used. The trailer 54 may connect to the coupling 184 via a kingpin 72 on a neck 70 of the trailer 54.

Bale wrapping is a mechanized agricultural process used primarily in the forage and silage industry to preserve and protect harvested crops, such as hay or straw. The process involves encasing a bale of forage in a layer of plastic film, which serves as a barrier to prevent moisture, air, and contaminants from affecting the quality of the stored crop. Bale wrapping machines, often mounted on tractors or other specialized equipment, wrap the bales tightly in multiple layers of plastic film. This wrapping process creates an airtight seal around the bale, which promotes anaerobic fermentation, effectively preserving the forage by inhibiting the growth of spoilage microorganisms. Bale wrapping helps maintain the nutritional value of the forage and extends its shelf life, making it a crucial technique for efficient forage storage and feed management in modern agriculture.

Dealing with spent bale wrapping materials, typically consisting of used plastic film or netting, is an important aspect of responsible agricultural and environmental management. Recycling and proper disposal are key considerations. Recycling options for spent bale wrapping materials often involve compacting and baling the used plastic film for transport to recycling facilities where it can be processed into new products. Some regions also offer recycling programs specifically tailored to agricultural plastics. Additionally, some farmers repurpose spent wrapping materials for other on-farm uses, such as weed control or erosion prevention. However, it's crucial to avoid burning or burying spent bale wrapping materials, as these practices can have detrimental environmental effects and are often regulated or prohibited in many areas due to the potential release of harmful substances. Proper disposal and recycling of these materials contribute to sustainable and environmentally responsible farming practices.

Cleaning up spent bale wrapping by collecting it and compressing it into a roll with twine for disposal is a practical approach to managing agricultural plastic waste. This process typically involves manually or mechanically gathering the used plastic film or netting from the field and winding it tightly into a compact roll. The use of twine or strapping helps secure the material in a manageable form for transport and disposal. While this method provides a convenient means of handling spent bale wrapping materials, it's important to ensure that the collected waste is properly disposed of or recycled in accordance with local regulations and environmental guidelines. Recycling facilities that accept agricultural plastics may provide specific guidelines for the preparation and delivery of materials, contributing to responsible waste management and minimizing the environmental impact of plastic waste in farming operations.

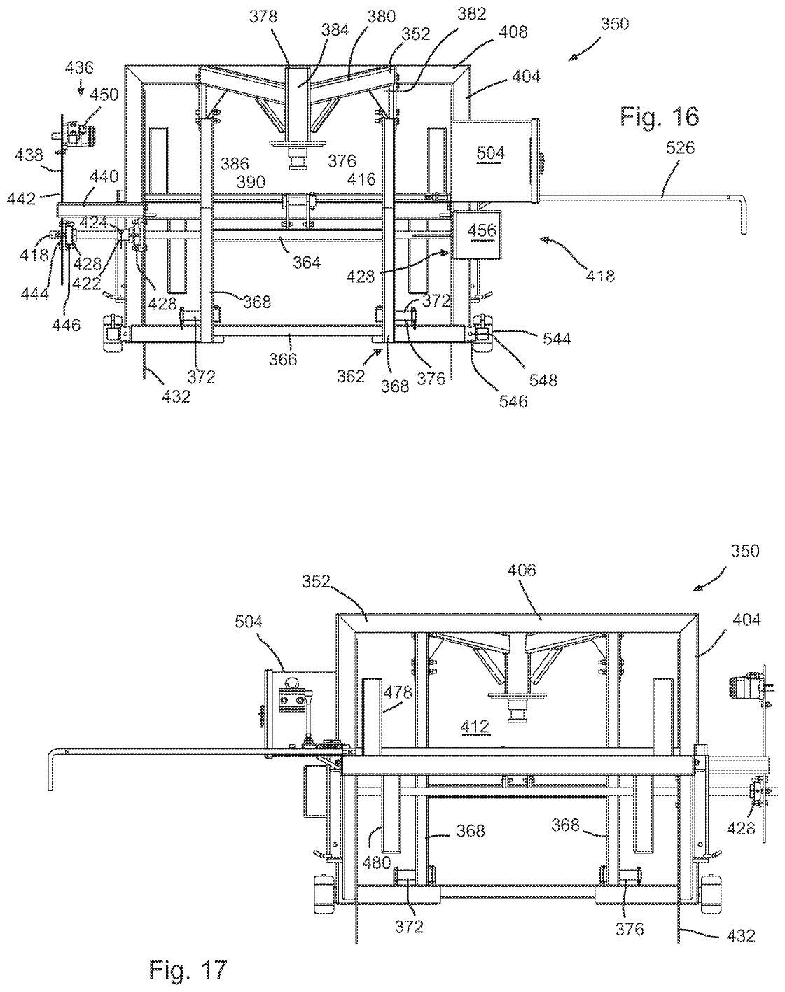

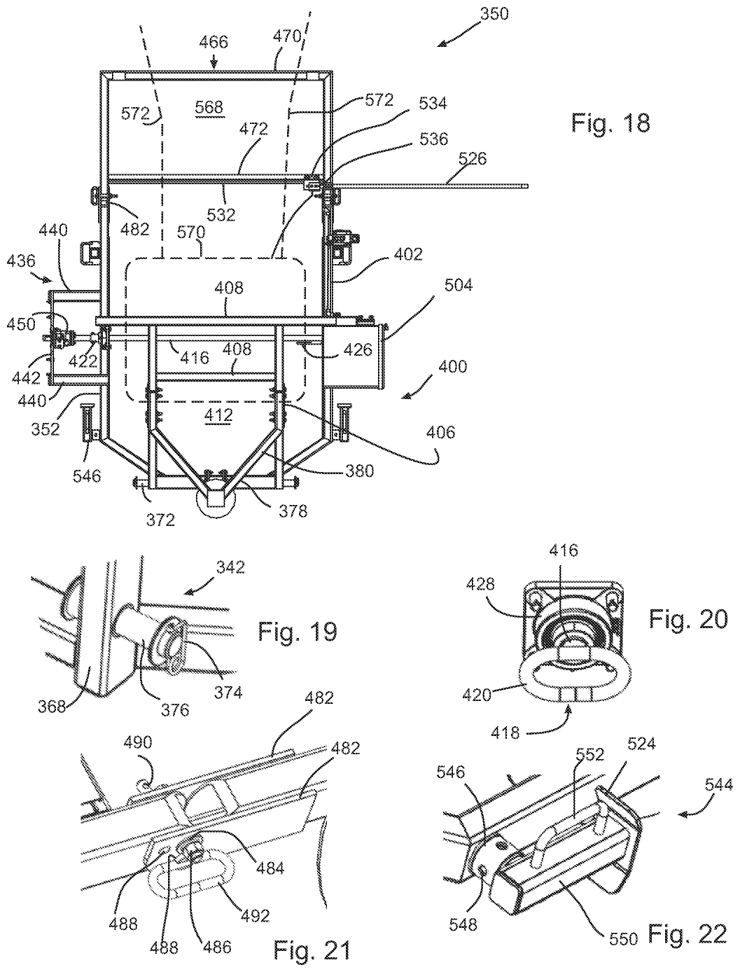

Referring to FIGS. 14-18, a bale wrap roller assembly 350 is illustrated for taking spent bale wrap and rolling it tightly into a roll for disposal or recycling. The assembly 350 comprises a structural frame 352, a hitch connector subframe 362, a wrap-receiving spool 414, and an actuator, such as a motor 450, to rotate the spool 414. The hitch connector may located at a leading end 354 of the structural frame 352, opposite a trailing end 356. The use of a hitch connector improves the manufacturing efficiency of a bale wrap roller assembly, because it negates the need for various standalone tailer-specific parts, such as wheels, axles, lights, and others, since the assembly 350 can be moved using only a tractor in a cantilevered stated and without touching the ground.

Referring to FIGS. 14-19, similar to the assembly 292, the assembly 350 may have a three-point hitch connector. The connector may have a three-point hitch connector subframe 362, which may be made of suitable structural members, such as top beam members 364, base beam members 366, and side posts 368. The three-point hitch connector may include a top connector 370 and side connectors 372. Each connector may be a quick-connect coupling, for example via the use of lynch pins 376 and clevis pins 374. Referring to FIGS. 14-15, the connectors shown may mount to the corresponding hooks of the quick-connect three-point hitch of adapter 82.

Referring to FIGS. 14-18, the hitch connector may comprise a fifth wheel connector. The fifth wheel connector may comprise a fifth wheel connector subframe 362, which may be made of suitable structural members, such as cantilevered side beam members 380, gusset brackets 382, and a center hitch post 384. Post 384 may have depending from it a kingpin 386. In other cases, a gooseneck adapter may be used at a base end 390 of the post 384, to mount to coupling 184 when no kingpin is present. A kingpin 386 may have an upper flange 392 and a lower flange 398 spaced along a post body 396, to permit the kingpin 386 to be locked within coupling 184.

Referring to FIGS. 14-18, the assembly 350 may comprise a roll-forming subframe 400. The subframe 400 may be made of suitable structural members, such as side beam members 402, side post members 404, side brace members 406, and upper cross beam members 308. In the example shown, the frame 400 forms a cage about which the spool 414 rotates in use, defining an interior 412 for the spool 414.

Referring to FIGS. 14-18, the spool 414 and associated assembly may have a suitable structure. The spool 414 may comprise a roller axle 416. The spool 414 may comprise roller discs 432 spaced from one another along the roller axle 416 to define a wrap-receiving zone (interior 412). The axle 416 may extend between opposed ends 418. The axle 416 may be mounted in bearing hubs 428, for example mounted to the frame 352, to permit the axle 416 to spin with minimal friction. In the example shown, bearing hubs 428 are mounted by fasteners 434 to roller discs 432 that form the flanges of the spool 414 (despite not rotating with the spool 414). One or both the roller axle 416 and the roller discs 432 may comprise a wrap hook part, such as a spline spear 426, that at least partially defines a wrap end-receiving slot. The wrap hook part may permit a leading end (not shown) of wrapping 568 to be secured to the axle 416 before driving the roller to coil the wrapping.

Referring to FIGS. 14-18, a roller drive assembly 436 may be provided. The assembly 436 may comprise a drive subframe 438, which may be made of suitable structural members, such as lateral beams 440 and a mounting plate 442. The motor 450 may be mounted to drive the roller axle 416, for example by an endless drive loop (not shown) such as a chain. The motor 450 may be mounted on the mounting plate 442. The plate 442 may define an axle aperture 444, housing a bearing hub 446, to support one end 418 of the axle 416. The motor 450 may have supply and return ports 452 to connect to the hydraulic power system of the tractor 10. A lock collar 422 with lynch pin 424 may be used to secure the end 418 near the motor 450 during rolling.

Referring to FIGS. 14-18 and 20, the axle 416 may be structured to be reversibly removed from the interior 412. An axle handle compartment 456 may be provided, for example on the frame 352, to receive the other end 418 of the axle 416, which may contain a handle, such as having an eye loop 420. The compartment 456 may house the bearing hub 428 that supports the end 418 within the interior 460 of the housing 458 that makes up the compartment 456. A gate 462, such as a hinged or removable gate, may be provided to cover the compartment 456. A lock, such as a latch 464 may be provided for the compartment 456. The roller axle 416 may be structured to move along a roller axis 417 between a locked, deployed position and a retracted position. When in the deployed position the roller axle is connected to be rotated by the motor 450. When in the retracted position the roller axle may be withdrawn from the wrap-receiving zone to release a roll of bale wrap in use.

Referring to FIGS. 14-18, the assembly 350 may comprise a wrap entry guide at a trailing end 355 of the structural frame 352. The wrap entry guide may comprise a wrap guide subframe 466, which comprises suitable structural members such as first and second entry beams 470 and 472, and side beams 474. Beams 470 and 472 may be parallel with one another and the wrap-receiving spool 414. Beams 470 and 472 may be spaced from one another, and oriented transverse to and along a feed axis 571 defined by the entry of wrapping into the wrap-receiving spool 414 in use. Subframe 466 may define leading and trailing ends 468 and 469, respectively. Upright guide posts 478 on beam 470, and down guide posts 480 on beam 472, may cooperate to define a feed path for the wrapping to pass through en route to spool 414, flattening as the wrapping passes.

Referring to FIGS. 14-18, and 21, the roller assembly 350 may be structured to pivot between deployed and stowed positions. The wrap guide subframe 466 may be connected to swing between a deployed position, in which the wrap guide subframe 466 extends outward along the feed axis 571 as shown, and a stowed position (not shown). In the example shown, the stowed position can be visualized by pivoting the subframe 466 upward relative to the frame 294. Pivot brackets 482 may connect the subframe 466 from the subframe 400, to permit pivoting. A pivot pin 486 may extend through aligned apertures 484 to provide a pivot axis for the movement. A locking lynch pin 490 may be selectively positioned through apertures 488 to lock the subframe 466 in one of a range of incremental positions defined by a plurality of apertures. A loop handle 492 may be provided to assist with the movement of the pin 490 or other fastener.

Referring to FIGS. 14-18 and 25, the bale wrap roller assembly 350 may comprise a mechanism for dispensing twine or other strapping material, to secure the roll in place once formed or during formation on the spool 414. The assembly 350 may comprise a twine feeder. The twine feeder may comprise a twine dispenser, such as a twine compartment 504, which may have a housing 506 defining an interior 508 in which a roll of twine may be stored in use. The housing 506 may have a suitable gate, with a lock 512 such as a latch. One or more twine guides, such as guide fittings 522 may be oriented to guide twine from the twine dispenser to wrap around the wrap-receiving spool 414 in use. In the example shown, twine is fed from compartment 504, out aperture 514, through a guide such as a guide bracket 518, and through various guide fittings 522 to a twine guide assembly 520. The twine feeder may comprise a twine feed bar 526. The bar 526 may be structured to receive twine from the twine guides and to slide along a rail assembly 532 transverse to the feed axis 571. The bar 526 may be oriented to move along a feedbar guide collar 524. The feed bar 526 may comprise a handle 528. A twine dispensing end 530 of the feedbar 526 may mount a rail trolley 534 with a twine feed bracket 536 and feed loop 538 for targeting the dispensing of twine where required along the length of the roll in use. Aligned apertures 540 in the trolley and bracket may be used to secure the trolley in place. Thus, after the spool 414 has been driven to wrap and coil the spent bale wrapping, the handle may be used while the roll is turned, to selectively dispense twine around the cylindrical side wall of the roll.

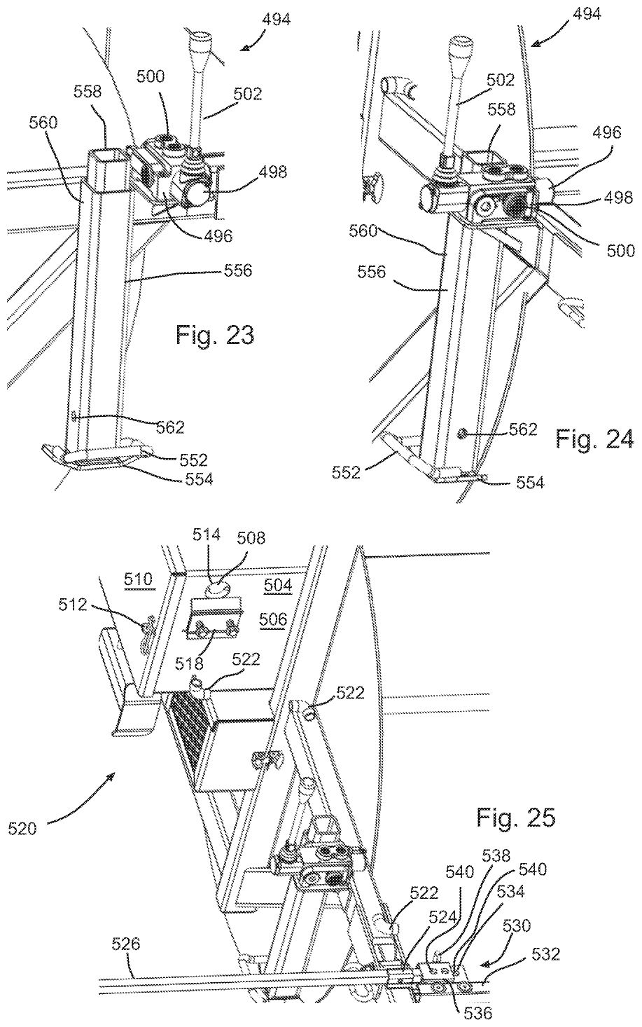

Referring to FIGS. 14-18 and 22-24, the assembly 350 may comprise suitable ground engaging members, such as legs assemblies 542. Assemblies 542 may form ground-engaging retractable legs that are configured to raise the structural frame 352 above a ground surface when deployed. Two different legs are shown for example. In FIG. 22, a swing leg 544 is provided. Leg 544 mounts to the frame via a mounting collar 546, which includes a series of pin apertures about a circumference of the collar 546, to permit the user to rotate the leg 544 until the desired orientation is achieved, followed by locking the leg 544 in that configuration using a lynch or other pin (not shown). Each leg may have a leg body 550, a handle 552, and a foot 554. In FIGS. 23-24, telescopic legs 556 are shown. Each telepost leg 556 may have a leg body collar 560 that mounts a mounting post 558, which mounts a foot 564 and a handle 552. An aperture 562 in collar 560 aligns in use with a series of apertures in the post 558 secured to frame 352 to permit locking the post 558 at a particular elevation with a pin or other fastener.

Referring to FIGS. 14-18, and FIGS. 23-24, the assembly 350 may comprise a power and control assembly 494. The assembly 494 may comprise one or more hydraulic valves 498, with various supply and return ports 500, and a control such as a control lever 502, to selectively operate the motor 450 and other mechanical aspects of the system to rotate the wrap-receiving spool to wrap a bale wrap 568 into a roll 570. The side edges 572 of the wrap 568 may contact and be guided by posts 478 and 480 to align the incoming wrapping with the spool 414, after which the wrapping is tightly rolled into a roll on the axle 416. When the wrapping is fully rolled, the user may use the twine dispense and feedbar while the roll 570 is turning in order to tightly strap the roll 570 together. When the roll 570 is complete, the user may open the handle compartment 456 and withdraw the axle 416 from the roll 570, leaving a finished roll. The roll 570 may now be taken for disposal or recycling.

The embodiments herein may be used in a variety of different ways with a variety of variations. For example, potential hydraulic 5th wheel attachments include flat deck trailers, bale transporters, fertilizer trailers, grain trailers, slight modification to 5th wheel hitches, balers, rakes & tedders, mower conditioners, wagons, rock windrowers, and plastic bag rollers. Although the assemblies 350 disclosed are cantilevered embodiments, it is also possible to provide versions that incorporate standalone trailer parts, such as wheels and axles.

### PART LIST

10 tractor
12 ground engaging members such
as wheels
14 cab
16 engine compartment
18 leading end
20 trailing end
22 hydraulic power system
24 three-point hitch on trailing
end of tractor
26 main body
28 PTO (power take-off)
30 stabilizing arm brackets
32 base adjuster stabilizing arms
34 hitch ends
36 pin apertures
38 center top link bracket
40 center top link arm
42 lift arm levelling assemblies
44 upper arm bracket
46 upper arms
48 length-adjustable rotatable
lift arms
50 crank on lift arms
52 threaded mounting arms/leveling
box drop arm
54 fifth-wheel trailer
56 leading end
58 trailing end
60 ground engaging wheels
62 deck
64 chassis
66 drop legs
68 loading ramp
70 neck
72 king pin
76 Hay bales
78 ends
80 cylindrical body
82 adapter
84 structural frame
86 leading end
87 trailing ends
88 upper beam member
90 side post members
92 top end
94 bottom end
96 outer side edges
98 inner sides
100 upper plate
102 pin collar
104 angled base members
106 lower edge
108 apex
110 base end
112 PTO passage defined below
lower edge
114 center post member
116 top end
118 bottom end
120 three-point hitch connector
on leading end
122 top connector
124 side connectors
126 bracket arms
128 pin apertures
130 three-point hitch on
trailing end
132 top connector
136 side connectors
138 hook arms
140 pin slot
142 open slot mouth
144 pin insertion axis
148 height adjustment bracket
for top connector
150 plurality of aligned
apertures
152 pins and flanges to
select height level
154 hitch locks
156 pin collar
158 pivot pin
160 pivot axis
162 flanges
164 cam lever plate
166 top end
168 base ramp
170 leading entry ramp
172 tip
174 biasing member
176 top end
178 bottom end
180 hooks
182 rings/mounts for
biasing member
184 5th wheel coupling
186 top face
188 base
190 leading end
191 trailing ends
192 sides
194 horseshoe top plate or plates
196 kingpin slot
198 mouth for kingpin slot
200 kingpin insertion axis
202 mouth insertion axis
204 ramp tips
206 leading skirt
208 coupling cover
210 top plate member
212 leading end member
214 slide gate bar guide slot
216 trailing end member
218 interior
220 kingpin slot
222 kingpin mouth
224 side member plates
226 pin apertures to couple
with pin collars
228 lynch pins for coupling cover
230 apertures for fasteners
232 fasteners - bolt lynch pins
234 nut
236 cross beams in interior
of coupling cover
238 L-shaped slide gate bar
240 gate arm
241 gate drive axis
242 drive axis
244 drive arm
246 actuator end
248 gate arm end
250 apertures in drive arm
252 hydraulic actuator
254 hydraulic cylinder
256 hydraulic ports to tractor
hydraulic system
258 piston
260 actuating end bracket
262 clevis pin for actuating end
264 drive axis
266 mounting bracket
268 manual release bar
270 handle
272 main body
274 actuating end bracket
276 clevis pin for actuating end
278 locking apertures along axis
280 release bar guide collar
282 aperture to align with
locking apertures
284 pin storage collar
286 pin
288 handle for pin
290 gate bar guide parts attached
to underside of coupler cover to
guide gate slide bar
292 bale spear assembly
294 frame
296 leading end
297 trailing ends
298 angled upper members
299 PTO passage defined below
lower edge
300 neck member at apex
302 top
304 base
306 upper hitch mount
310 aperture for pin in lower
hitch mount
312 ball hitch
314 side post members
316 base beam member
318 female part/apertures
for spears
320 lower hitch mount
322 aperture for pin
324 bale spears
326 base
328 male part for apertures
330 sleeve
332 threaded end
334 nut
336 tips
338 three-point hitch connector
340 top connector
342 side connectors
344 bracket arms
346 lynch pins
350 Bale wrap roller assembly
352 structural frame
354 leading end
355 trailing end
356 top
358 base
360 sides
362 three-point hitch connector
subframe
364 top beam members
366 base beam members
368 side posts
370 top connector
372 side connectors
374 clevis pins
376 lynch pins
378 fifth wheel connector subframe
380 cantilevered side beam members
382 gusset brackets to mount
side beam members
384 center hitch post
386 king pin
388 top end
390 base end
394 upper flange
396 post body
398 lower flange
400 Roll subframe
402 side beam members
404 side post members
406 side brace members
408 upper cross beam members
412 roll-forming interior
414 Spool
416 axle
417 roller axis
418 opposed ends
420 eye loop handle at one end
422 lock collar at other end
424 lynch pin for lock collar
426 spline spear
428 bearing hubs for the ends
of the axle
432 side discs
434 fasteners to secure side
discs to the subframe
436 Roll drive assembly
438 drive sub frame
440 lateral beams
442 mounting plate
444 axle aperture
446 axle hub
450 hydraulic motor
452 hydraulic power fluid port
456 Axle handle compartment
458 housing
460 interior
462 gate
464 latch
466 bale wrap guide subframe
468 leading end
469 trailing end
470 first entry beam
472 second entry beam
474 side beams
476 leading ends
478 upright guide posts
480 down guide posts
482 Pivot brackets for bale
wrap guide subframe
484 aperture for pivot pin
486 pivot pin
488 aperture for lock pin
490 lock lynch pin
492 loop handle
494 Power and control assembly
for bale roller
496 control mounting bracket
498 hydraulic valves
500 hydraulic input and
output ports
502 control lever
504 Twine compartment
506 twine housing
508 interior
510 gate
512 latch/lock
514 aperture in housing to hold
and dispense twine
518 guide bracket
520 Twine roller guide assembly
522 guide fittings
524 feedbar guide collar
526 feed bar
528 handle
530 twine dispensing end
532 rail assembly for feed bar
534 rail trolley for twine
dispensing end
536 twine feed bracket
538 twine feed loop
540 aligned apertures in trolley
and twine feed bracket
542 Leg assemblies
544 swing legs
546 mounting collars
548 series of pin apertures
in collar
550 leg body
552 handle
554 feet
556 telepost legs
558 mounting post
560 leg body collar
562 alignment pin apertures
564 feet
566 bale wrap
568 incoming bale wrap
570 roll of bale wrap
571 feed axis
572 side edges of wrap
574 twine

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A three-point hitch adapter comprising:
a structural frame;
a three-point hitch connector at a leading end of the structural frame;
a three-point hitch at a trailing end of the structural frame; and
a fifth wheel coupling mounted on the structural frame.

2. The three-point hitch adapter of claim 1 in which the fifth wheel coupling comprises a top plate that defines a kingpin-receiving slot.

3. The three-point hitch adapter of claim 2 in which the top plate is secured above or forms part of a coupling cover that mounts by reversible connectors to an upper member of the structural frame.

4. The three-point hitch adapter of claim 3 in which the structural frame comprises opposed upright post members, and the reversible connectors comprises fasteners passed through aligned apertures in the coupling cover and the upright post members.

5. The three-point hitch adapter of claim 4 in which the fasteners comprise lynch pins that extend parallel and coaxial with one another.

6. The three-point hitch adapter of claim 2 further comprising a kingpin gate lock that is structured to move between a retracted position in which a lateral mouth of the kingpin-receiving slot is unobstructed, and a locked position in which the lateral mouth is blocked to prevent kingpin removal.

7. The three-point hitch adapter of claim 6 in which the gate lock comprises a slide bar.

8. The three-point hitch adapter of claim 7 in which the slide bar is connected to a hydraulic actuator.

9. The three-point hitch adapter of claim 8, in which the slide bar is connected to a manual release bar for manual operation of the slide bar.

10. The three-point hitch adapter of claim 7 further comprising a slide bar lock.

11. The three-point hitch adapter of claim 1 in which the three-point hitch comprises a pair of base quick-connect hooks and a top quick-connect hook.

12. The three-point hitch adapter of claim 11 in which the top quick-connect hook is structured to be selectively lockable in a range of different elevation positions relative to the pair of base quick-connect hooks.

13. The three-point hitch adapter of claim 11 further comprising quick-connect locks, for each of the pair of base quick-connect hooks, and that are biased to permit entry but prevent exit of a lateral pin from a three-point hitch connector.

14. A combination, comprising:
the three-point hitch adapter of claim 1; and
a tool apparatus, which has a three-point hitch connector that is mounted to the three-point hitch of the three-point hitch adapter.

15. The combination of claim 14 in which the tool apparatus comprises a bale spear.

16. The combination of claim 14 in which the tool apparatus comprises a bale wrap roller.

17. The combination of claim 14 in which each of the tool apparatus and the three-point hitch adapter comprise structural frame members that are oriented to collectively define a power take off passage through both the tool apparatus and the three-point hitch adapter.

18. The combination of claim 14 further comprising a fifth wheel trailer hitched to the fifth wheel coupling.

19. A method comprising connecting a fifth wheel trailer to the fifth wheel coupling.

20. A bale wrap roller assembly comprising:
a structural frame;
a hitch connector at a leading end of the structural frame;
a wrap-receiving spool; and
a motor connected to rotate the wrap-receiving spool.
